(19) United States
(12) Patent Application Publication
(10) Pub. No.: US 2020/0337207 A1
(43) Pub. Date: Oct. 29, 2020

(54) SYSTEM AND METHOD FOR CONTROLLING DOWNFORCE ON A MULTI-WING AGRICULTURAL IMPLEMENT

(71) Applicant: CNH Industrial America LLC, New Holland, PA (US)

(72) Inventor: Brian J. Anderson, Yorkville, IL (US)

(21) Appl. No.: 16/395,750

(22) Filed: Apr. 26, 2019

(51) Int. Cl. A01B 63/32; A01B 63/00; F15B 13/044

(52) U.S. Cl. CPC A01B 63/32; F15B 13/044; A01B 63/008

(57) ABSTRACT

A system for controlling downforce on a multi-wing agricultural implement has a first frame section and a second frame section pivotably coupled to the first frame section and configured to support a plurality of row units. An actuator of the implement actuates the second frame section relative to the first frame section to maintain downforce on the row units. Specifically, the actuator defines first and second fluid chambers, where a first control valve is configured to regulate a supply of fluid to the first fluid chamber and a second control valve is configured to regulate a supply of fluid to the second fluid chamber. A controller controls at least one of the first or second control valves to maintain a pressure differential between the fluid supplied to the first and second chambers within a target threshold range.

### FIELD OF THE INVENTION

The present subject matter relates generally to agricultural implements, and, more particularly, to a system and method for controlling downforce on a multi-wing agricultural implement.

### BACKGROUND OF THE INVENTION

A wide range of farm implements have been developed and are presently in use for tilling, planting, harvesting, and so forth. Planters, for example, are commonly towed behind tractors and may cover wide swaths of ground for planting. To make agricultural operations as efficient as possible, wide swaths of ground may be covered by extending wing assemblies along either side of the implement being pulled by the tractor. Typically, the wing assemblies include one or more toolbars, various ground engaging tools mounted on the toolbar(s), and one or more associated support wheels. The wing assemblies are commonly disposed in a “floating” arrangement during an agricultural operation, wherein actuatable cylinders allow the ground-engaging tools to contact and engage the ground. For transport, the wing assemblies are elevated by the support wheels to disengage the ground-engaging tools from the ground and may optionally be folded, stacked, and/or pivoted by the cylinders to reduce the width of the implement.

When performing a planting operation, a wing downforce is applied to the wing assemblies by associated cylinders to keep the ground-engaging tools in proper engagement with the ground, particularly in an uneven or hilly field. In conventional systems, downforce control is provided by regulating the fluid pressure to one side of each cylinder (e.g., the cap end or the rod end of the cylinder). However, due to size and backpressure constraints on the cylinders, such a control strategy significantly limits the control range and resolution of the cylinders, thereby reducing the ability to regulate the downforce applied to the associated ground-engaging tools.

Accordingly, an improved system and related method for controlling downforce on a multi-wing agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one embodiment, the present subject matter is directed to a system for controlling downforce on a multi-wing agricultural implement. The system includes a first frame section and a second frame section pivotably coupled to the first frame section, where the second frame section is configured to support a plurality of row units. The system further includes an actuator configured to actuate the second frame section relative to the first frame section during operation of the agricultural implement to maintain downforce on the plurality of row units. The actuator defines a first fluid chamber and a second fluid chamber. Additionally, the system includes a first control valve configured to regulate a supply of fluid to the first fluid chamber of the actuator, a second control valve configured to regulate a supply of fluid to the second fluid chamber of the actuator, and a controller configured to control an operation of at least one of the first control valve or the second control valve to maintain a pressure differential between the fluid suppled to the first and second fluid chambers of the actuator within a target threshold range.

In another embodiment, the present subject matter is directed to a method for controlling downforce on a multi-wing agricultural implement. The multi-wing agricultural implement includes a first frame section, a second frame section pivotably coupled to the first frame section, and an actuator configured to actuate the second frame section relative to the first frame section. The actuator defines a first fluid chamber and a second fluid chamber. The agricultural implement further includes a first control valve configured to regulate a supply of fluid to the first fluid chamber of the actuator, and a second control valve configured to regulate a supply of fluid to the second fluid chamber of the actuator. The method includes receiving, with a computing device, data associated with a first fluid pressure of the fluid supplied to the first fluid chamber of the actuator. Further, the method includes receiving, with the computing device, data associated with a second fluid pressure of the fluid supplied to the second fluid chamber of the actuator. Moreover, the method includes determining, with the computing device, a pressure differential between the fluid supplied to the first and second fluid chambers of the actuator based on the data associated with the first and second fluid pressures. Additionally, the method includes controlling, with the computing device, an operation of at least one of the first control valve or the second control valve to maintain the determined pressure differential within a target threshold range.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a multi-wing agricultural implement in accordance with aspects of the present subject matter;

FIG. 2 illustrates a schematic view of one embodiment of a system for controlling downforce on a multi-wing agricultural implement in accordance with aspects of the present subject matter; and

FIG. 3 illustrates a flow diagram of one embodiment of a method for controlling downforce on a multi-wing agricultural implement in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for controlling downforce on a multi-wing agricultural implement. Specifically, in several embodiments, the agricultural implement may include an inner frame section and an outer frame section pivotably coupled to the inner frame section, with at least one of the frame sections being configured to support a plurality of ground engaging tools (e.g., one or more ground engaging tools of a plurality of row units). Additionally, an actuator (e.g., a cylinder) is coupled between the inner and outer frame sections and is configured to actuate the outer frame section relative to the inner frame section, or vice versa, to apply and/or maintain a downforce on the frame section(s) to keep the ground engaging tools of the row units in proper engagement with the ground.

In several embodiments, the disclosed system may include control valves in fluid communication with the actuator for controlling the pressure of fluid supplied to respective chambers of the actuator. For example, the actuator may be configured as an actuating cylinder having a cap end and a rod end. In such an embodiment, the system may include a first control valve configured to regulate the supply of pressurized fluid to the rod end of the actuating cylinder and a second control valve configured to regulate the supply of pressurized fluid to the cap end of the actuating cylinder. As such, to provide downforce control, the first and second control valves may be controlled to maintain a pressure differential between the pressurized fluid supplied to the opposed ends of the actuating cylinder within a target threshold range corresponding to a desired range of suitable downforce pressures for maintaining the ground-engaging tools in proper engagement with the ground. In this regard, each of the first and second control valves may, for example, correspond to a pressure regulating valve that is independently controllable to adjust the respective pressures of the fluid supplied to the opposed ends of the actuating cylinder to maintain the pressure differential within the target threshold range.

Moreover, in several embodiments, the disclosed system may also include a controller and first and second pressure sensors communicatively coupled to the controller to allow the controller to monitor the pressure of the fluid being supplied to the opposed ends of the actuating cylinder. In such embodiments, the controller may receive the pressure measurements or sensor data provided by the sensors and automatically control the operation of the first and second control valves based on such sensor feedback to maintain the desired pressure differential between the pressures of the pressurized fluid supplied to the opposed ends of the actuating cylinder within the target threshold range. In other embodiments, the controller may be configured to control the operation of the first and second control valves based on an input received from an operator, such as an input requesting that the pressure differential between the pressurized fluid supplied to the opposed ends of the actuating cylinder be adjusted (e.g., to adjust the desired downforce to be applied to the frame section(s)).

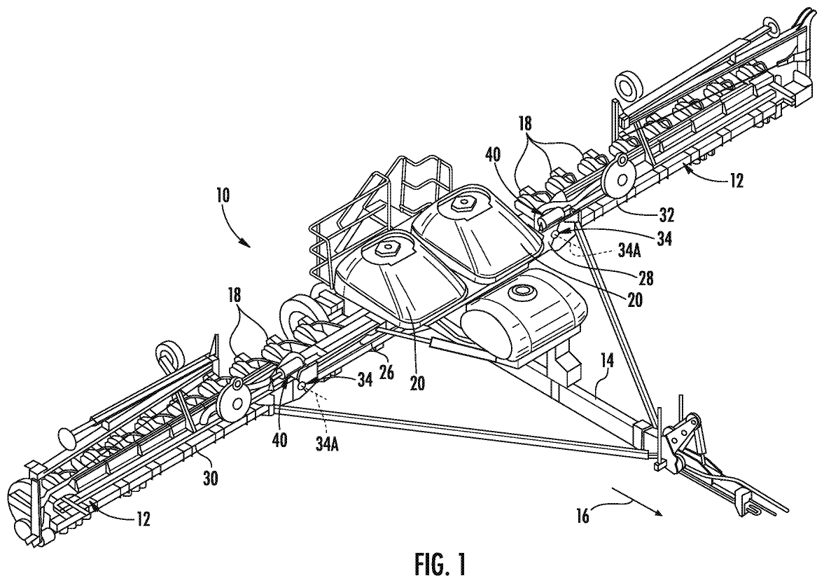

Referring now to FIG. 1, a perspective view of one embodiment of a multi-wing agricultural implement 10 is illustrated in accordance with aspects of the present subject matter. As shown, the implement 10 is configured as a multi-wing planter, particularly as a front-fold planter. However, in other embodiments, the implement 10 may have any other suitable implement configuration, such as by being configured as any other suitable multi-wing implement (e.g., a tiller, seeder, sprayer, fertilizer, and/or the like).

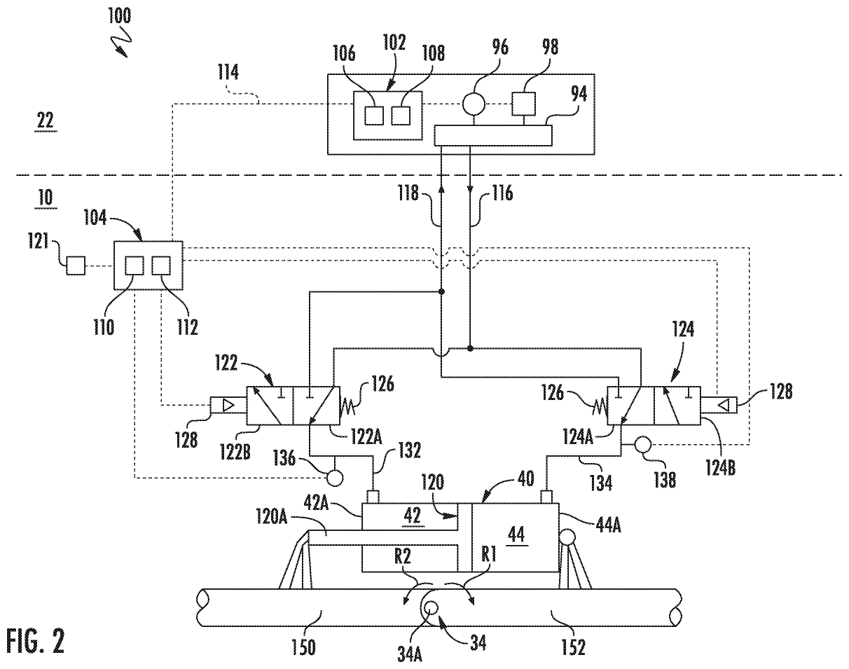

As shown in FIG. 1, the implement 10 includes a laterally extending toolbar or frame assembly 12 connected at its middle to a forwardly extending tow bar 14 to allow the implement 10 to be towed by a work vehicle 22 (shown schematically in FIG. 2), such as an agricultural tractor, in a direction of travel (e.g., as indicated by arrow 16). The frame assembly 12 may generally be configured to support a plurality of seed planting units (or row units) 18. As is generally understood, each row unit 18 may have at least one ground-engaging tool (e.g., one or more reside managers, opener discs, closing discs, gauge wheels, press wheels, and/or the like) configured to allow seeds (e.g., stored in one or more hoppers or seed tanks 20) to be deposited at a desired depth beneath the soil surface and at a desired seed spacing as the implement 10 is being towed by the work vehicle, thereby establishing rows of planted seeds. Additionally, one or more fluid tanks may store agricultural fluids, such as insecticides, herbicides, fungicides, fertilizers, and/or the like. It should be appreciated that, for purposes of illustration, only a portion of the row units 18 of the implement 10 have been shown in FIG. 1. In general, the implement 10 may include any number of row units 18, such as 6, 8, 12, 16, 24, 32, or 36 row units.

Further, as shown in FIG. 1, the implement 10 is configured as a multi-wing implement including a plurality of frame sections. Specifically, in the illustrated embodiment, the implement 10 includes left and right central or inner frame sections 26, 28 and left and right outer frame sections 30, 32 pivotably coupled to the respective left and right inner frame sections 26, 28. For example, the left outer frame section 30 is pivotably coupled to the left inner frame section 26 and the right outer frame section 32 is pivotably coupled to the right inner frame section 28 by respective pivot joints 34. As is generally understood, the pivot joints 34 may be configured to allow relative pivotal motion between adjacent frame sections of the implement 10. For example, the pivot joints 34 may allow for articulation of the various frame sections during an agricultural operation of the implement 10, such as a planting operation.

Additionally, in accordance with aspects of the present subject matter, the implement 10 may include one or more down pressure actuators 40, where each actuator 40 is configured to actuate one frame section of a pair of adjacent frame sections relative to the other frame section of the pair of adjacent frame sections. For example, by retracting or extending the actuators 40 of the implement 10, the left and right outer frame sections 30, 32 may be pivoted relative to the respective left and right inner frame sections 26, 28 about the pivot joints 34. In general, as will be discussed in greater detail below, the operation of each actuator 40 may be controlled to maintain the downforce applied to the associated frame section at a given level or within a desired range, thereby ensuring that the associated ground engaging tools of the row units 18 are maintained in proper engagement with the ground during an agricultural operation. In some embodiments, the same actuators 40 may be used to fold, stack, or pivot adjacent frame sections to reduce the width of the implement 10 for transport purposes. However, in other embodiments, the actuators 40 may only be used to provide downforce on the various frame sections.

In several embodiments, the actuators 40 described above may correspond to fluid-activated actuators, such as, for example, hydraulic or pneumatic cylinders. In such embodiments, the operation of the actuators 40 may be controlled by regulating the pressure of working fluid (e.g., air or oil) supplied thereto. For instance, as will be described below, suitable control valves may be used to regulate the supply of working fluid to corresponding fluid chambers of each actuator 40.

It should also be appreciated that the configuration of the implement 10 described above and shown in FIG. 1 is provided only to place the present subject matter in an exemplary field of use. Thus, it should be appreciated that the present subject matter may be readily adaptable to any manner of implement configuration. For example, in an alternative embodiment, the implement 10 may include further outer frame sections coupled to the left and right outer frame sections 30, 32 and/or may include only a single inner frame section to which the left and right outer frame sections 30, 32 are coupled. Similarly, in another embodiment, adjacent frame sections may instead be indirectly coupled together, for example, by a linkage assembly including one or more linkages and pivot joints. For example, the implement may instead be configured as a gull-wing implement, such as the gull-wing planter described in U.S. Pat. No. 8,868,303, which is hereby incorporated by reference herein in its entirety for all purposes.

Referring now to FIG. 2, a schematic view of one embodiment of a system 100 for controlling downforce on a multi-wing agricultural implement is illustrated in accordance with aspects of the present subject matter. As will be described below, the system 100 allows for actuation of a first frame section 150 relative to an adjacent second frame section 152 of the implement to maintain downforce on the row units on at least one of the first or second frame sections of the implement. For purposes of discussion, the system 100 will be described herein with reference to the implement 10 described above and shown in FIG. 1. In general, it should be understood that the first and second frame sections 150, 152 shown in FIG. 2 may correspond to any adjacent frame sections of an implement, such as one or more pairs of adjacent frame sections of the implement 10 described above. For example, the first and second frame sections 150, 152 may correspond to the left inner and outer frame sections 26, 30 or the right inner and outer frame sections 28, 32 shown in FIG. 1. Additionally, it should be appreciated that fluid couplings of the system 100 shown in FIG. 2 are indicated by solid lines. Similarly, communicative links or electrical couplings of the system 100 shown in FIG. 2 are indicated by dashed lines.

In general, it is typically desired for an agricultural implement, such as the implement 10 described above with reference to FIG. 1, to be configured such that, when the implement 10 is performing an agricultural operation, the frame sections 150, 152 are kept at a desired position relative to the ground surface so that the ground-engaging tools of the row units 18 may maintain proper engagement with the ground. However, when the implement 10 performs an agricultural operation on a hilly or uneven field, or a field with varying soil hardness, the frame sections 150, 152 may not stay at the desired position relative to the ground surface for proper engagement of the ground-engaging tools with the ground. Therefore, downforce on one or more of the first and second frame sections 150, 152 is needed. With higher pressure requirements for the downforce, however, greater control resolution and performance is desired for the downforce actuators 40.

As shown in FIG. 2, the system 100 includes both a vehicle controller 102 installed on and/or otherwise provided in operative association with the work vehicle 22 configured to tow the implement 10 and an implement controller 104 installed on and/or otherwise provided in operative association with the implement 10. In general, each controller 102, 104 of the disclosed system 100 may correspond to any suitable processor-based device(s), such as a computing device or any combination of computing devices. Thus, in several embodiments, the vehicle controller 102 may include one or more processor(s) 106 and associated memory device(s) 108 configured to perform a variety of computer-implemented functions, such as automatically controlling the operation of one or more components of the work vehicle 22. Similarly, as shown in FIG. 2, the implement controller 104 may include one or more processor(s) 110 and associated memory devices 112 configured to perform a variety of computer-implemented functions, such as automatically controlling the operation of one or more components of the implement 10.

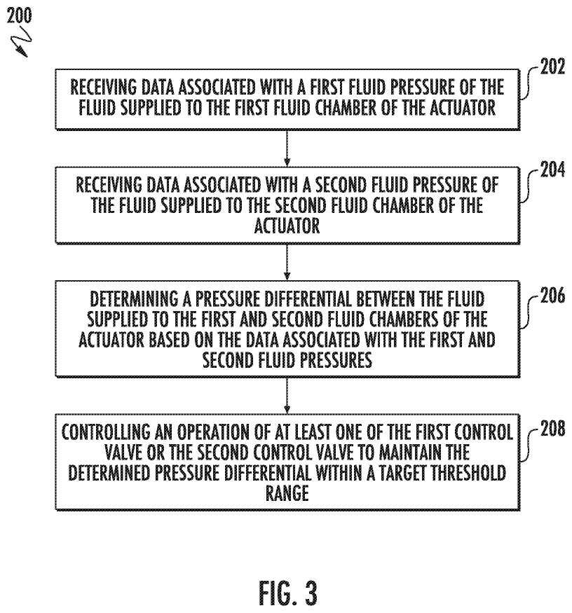

It should be appreciated that, as used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 108, 112 of each controller 102, 104 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 108, 112 may generally be configured to store suitable computer-readable instructions that, when implemented by the processor(s) 106, 110 of each controller 102, 104, configure the controller 102, 104 to perform various computer-implemented functions, such as performing the various operations, control functions and/or control actions described herein and/or implementing one or more aspects of the method 200 described below with reference to FIG. 3. Additionally, it should be appreciated that, while the memory 108, 112 is shown as being an integral part of, or local to the controllers 102, 104, the memory 108, 112 may instead have any other configuration. For instance, in some embodiments, the memory 108, 112 may be positioned remotely from the controller 102, 104, such that the controller 102, 104 may be configured to access computer-readable instructions and/or data stored in the memory 108, 112 via a wireless network connection (e.g., data stored on a cloud-based server).

In addition, each controller 102, 104 may also include various other suitable components, such as a communications circuit or module, a network interface, one or more input/output channels, a data/control bus and/or the like, to allow each controller 102, 104 to be communicatively coupled to the other controller and/or to any of the various other system components described herein. For instance, as shown in FIG. 2, a communicative link or interface 114 (e.g., a data bus) may be provided between the vehicle controller 102 and the implement controller 104 to allow the controllers 102, 104 to communicate with each other via any suitable communications protocol. Specifically, in one embodiment, an ISOBus Class 3 (ISO11783) interface may be utilized to provide a standard communications protocol between the controllers 102, 104. Alternatively, a proprietary communications protocol may be utilized for communications between the vehicle controller 102 and the implement controller 104.

As shown in FIG. 2, the vehicle controller 102 may be communicatively coupled to one or more valve assemblies, such one or more vehicle-based valve assembly(ies) 94 located on and/or within the work vehicle 22 configured to tow the implement 10, to regulate the supply of hydraulic fluid from a pump and associated fluid tank or supply. For example, the work vehicle 22 may include a pump 96 configured to supply a flow of pressurized fluid from a fluid supply 98 to valve assembly(ies) 94. Based on control signals from the vehicle controller 102 (which may, in certain instances, be initiated by the implement controller 104 and/or an operator of the work vehicle 22), the valve assembly(ies) 94 may regulate the supply of hydraulic fluid from the fluid supply 98 to various implement-based actuators of the implement 10 (e.g., the actuators 40), such as by restricting or enabling fluid flow from the fluid supply 98 into the actuators via one or more hydraulic lines, such as via a supply line 116. Alternatively, the implement controller 104 may be configured to override the vehicle controller 102 and may directly control the supply of hydraulic fluid through the valve assembly(ies) 94.

In the embodiment shown in FIG. 2, the actuator 40 is configured as a cylinder having a piston 120 with an associated connector rod 120A. The piston 120 defines a first fluid chamber 42 at a rod side 42A of the actuator 40 and a second fluid chamber 44 at a cap side 44A of the respective cylinder 40. The connector rod 120A of the actuator 40 is pivotably coupled to the first frame section 150 of the implement 10, and the cap side 44A of the actuator 40 is pivotably coupled to the second frame section 152 of the implement 10. Generally, as the pressure differential or difference between the first and second fluid chambers 42, 44 is adjusted such that the fluid pressure within the first fluid chamber 42 is greater than the fluid pressure within the second fluid chamber 44, the actuator 40 reduces downforce on one of the corresponding first or second frame sections 150, 152.

For example, with the actuator 40 shown in FIG. 2, when the pressure of the fluid supply to the first fluid chamber 42 is greater than the pressure of the fluid supply to the second fluid chamber 44, the pressure differential between the fluid pressures supplied to the first and second pressure chambers 42, 44 causes the actuator 40 to retract. As the actuator 40 retracts, the first frame section 150 moves in a first pivoting direction R1 about a pivot axis 34A defined by the pivot joint 34 relative to the second frame section 152, thus reducing the downforce on the first frame section 150. Similarly, as the pressure differential between the first and second fluid chambers is adjusted such that the fluid pressure within the first fluid chamber 42 is less than the fluid pressure within the second fluid chamber 44, the pressure differential between the fluid pressures supplied to the first and second pressure chambers 42, 44 causes the actuator 40 to extend. As the actuator 40 extends, the first frame section 150 moves in a second pivoting direction R2 about the pivot axis 34A relative to the second frame section 152, thus increasing the downforce on the first frame section 150.

It should be appreciated that, in general, by increasing downforce on the first frame section 150, the downforce on the second frame section 152 may be correspondingly decreased, and vice versa. Additionally, it should be appreciated that as the fluid supply to the first and second fluid chambers 42, 44 changes, the fluid chamber of the actuator 40 that is to be supplied less fluid pressure from the supply line 116 may release at least some of its fluid pressure through a drain line 118.

In accordance with aspects of the present subject matter, the system 100 may further include control valves 122, 124 fluidly coupled to the supply line 116 between the valve assembly 94 and the actuator 40 and configured to regulate the flow rate and/or pressure of the fluid being supplied to the actuators 40 of the implement 10. For example, in the embodiment of the system 100 shown in FIG. 2, the control valves 122, 124 are configured as pressure regulating valves. In this regard, the control valves 122, 124 will be referred to hereafter as “pressure regulating valves 122, 124” for the sake of simplicity and without intent to limit. The pressure regulating valves 122, 124 are configured to regulate the flow rate and/or supply pressure of the fluid being supplied to the first and second fluid chambers 42, 44 of the actuator 40. In such embodiment, a first pressure regulating valve 122 is fluidly coupled between the supply line 116 and the first fluid chamber 42 at the rod side 42A of the actuator 40, and a second pressure regulating valve 124 is fluidly coupled between the supply line 116 and the second fluid chamber 44 at the cap side 44A of the actuator 40.

In several embodiments, each pressure regulating valve 122, 124 corresponds to a spring-biased, solenoid-operated valve, actuatable between an opened or return position 122A, 124A and a closed position 122B, 124B, with each pressure regulating valve 122, 124 being biased towards its opened position 122A, 124A by the biasing action of an associated spring 126. In some embodiments, the operation or pressure setting of each pressure regulating valve 122, 124 may be varied to adjust the fluid pressure supplied to the respective actuator fluid chambers 42, 44 when in the opened position. For example, the operation of the pressure regulating valves 122, 124 may be automatically controlled (e.g., via the implement controller 204) to adjust the output pressure or pressure setting of each pressure regulating valve 122, 124.

As shown in FIG. 2, each solenoid-operated pressure regulating valve 122, 124 generally includes an actuating mechanism, such as a solenoid 128. In such an embodiment, each solenoid 128 may be configured to receive one or more signals, i.e., a control inputs or electrical inputs, from the implement controller 104 via a communication link. Upon receiving suitable control inputs from the implement controller 104, the solenoid 128 may be configured to actuate the respective pressure regulating valve 122, 124 between its opened position 122A, 124A (as shown in FIG. 2) and its closed position 122B, 124B. As a result, by controlling the solenoids 128, the implement controller 104 may be configured to automatically adjust the output pressure settings for the pressure regulating valves 122, 124, thereby regulating the fluid pressure supplied to the first and second fluid chambers 42, 44 of the actuator 40. In such an embodiment, the implement controller 104 may be configured to automatically adjust the output pressure settings based on sensor data received from one or more sensors and/or based on inputs received from the operator. For instance, the operator may be provided with a suitable input device 121 (e.g., buttons, a control knob, etc.) within the cab that allows the operator to provide an input instructing the controller 104 to increase or decrease the output pressure setting for the valves 122, 124.

In one embodiment, the system 100 includes a plurality of sensors, such as flow or pressure sensors, for monitoring the fluid pressure supplied to the first and second fluid chambers 42, 44 of the actuator 40 by the respective first and second pressure regulating valves 122, 124. More particularly, as shown in FIG. 2, the first pressure regulating valve 122 is configured to supply pressurized fluid to the first fluid chamber 42 through a first conduit 132 and the second pressure regulating valve 124 is configured to supply pressurized fluid to the second fluid chamber 44 through a second conduit 134. At least one first pressure sensor 136 may be fluidly coupled to the first conduit 132 so as to provide a signal or measurement data indicative of a flow parameter, such as a first fluid pressure, of the fluid being supplied from the first pressure regulating valve 122 through the first conduit 132 to the first fluid chamber 42. Similarly, at least one second pressure sensor 138 may be fluidly coupled to the second conduit 134 so as to provide a signal or measurement data indicative of a flow parameter, such as a second fluid pressure, of the fluid being supplied from the second pressure regulating valve 124 through the second conduit 134 to the second fluid chamber 44. Such output signals or data from the first and second pressure sensors 136, 138 may then be transmitted to the implement controller(s) 104 for subsequent processing, analysis, and/or storage.

For instance, the controller(s) 104 may be configured to analyze the sensor data received from the first and second pressure sensors 136, 138 to determine a pressure differential between the first and second fluid pressures corresponding to a pressure differential between the fluid supplied to the first and second fluid chambers. The controller(s) 104 may further be configured to independently monitor the pressure differential between the first and second fluid pressures supplied to the first and second fluid chambers 42, 44 of the actuator 40, respectively. The pressure differential between the first and second fluid pressures generally corresponds to the downforce acting on the associated frame sections. Thus, in such an embodiment, the controller(s) 104 may, for example, utilize the pressure differential between the first and second fluid pressures as a reference value, and control the downforce acting on the associated frame section(s) 150, 152 based on a comparison between the monitored pressure differential and a target threshold range spanning a range of pressure differential values associated with a desired downforce range for the associated frame section(s) 150, 152.

When the implement 10 is performing an agricultural operation, the controller(s) 104 may be configured to monitor the pressure differential between the first and second fluid pressures and compare the detected pressure differential between the first and second fluid pressures to the predetermined or operator-selected target threshold range. In one embodiment, the target threshold range may be, for example, within about 10 pounds-per-square-inch (psi), or such as within about 5 psi, of a desired pressure differential between the first and second fluid pressures, where the desired pressure differential corresponds to a desired downforce to be applied to the associated frame section(s). If the detected pressure differential between the first and second fluid pressures falls outside of the target threshold range, the controller(s) 104 may determine that the downforce on the frame sections 150, 152 should be adjusted. The controller(s) 104 may then be configured to adjust the operation of one or both of the pressure regulating valves 122, 124, e.g., by electrically actuating the solenoids 128 to change the pressure(s) of the fluid supplied to the first fluid chamber 42 and/or the second fluid chamber 44 to bring the pressure differential back within the target threshold range.

It should be appreciated that the example target threshold ranges described above are provided merely for the purposes of discussion and should not be construed as limiting. Instead, it should be readily appreciated that any suitable target threshold range may be chosen such that the downforce provided by the pressure differential allows the ground-engaging tools of the row units 18 to properly engage the ground surface for consistent working of the soil, and more particularly, e.g., seeding depth.

It should also be appreciated that, in several embodiments, the operator may be allowed to provide an input, e.g., via the user interface 121, associated with the selection of a desired pressure differential and/or a desired target threshold range. In such embodiments, the user interface 121 may generate a control input which is received by the controller 104 to allow the controller 104 to actively control the operation of the valve(s) 122, 124 based on the operator-selected pressure differential and/or target threshold range. The pressure differential/range may be selected, for example, based on the seed type, soil conditions, field levelness and/or number of row units.

It should be appreciated that while the control operations of the system 100 has been described with reference to the implement controller(s) 104, the vehicle controller 102 may instead be configured to perform one or more of the operations of the system 100, or the implement and vehicle controllers 102, 104 may be configured to share the control operations of the system 100.

Referring now to FIG. 3, a flow diagram of one embodiment of a method 200 for controlling down pressure on a multi-wing agricultural implement is illustrated in accordance with aspects of the present subject matter. In general, the method 200 will be described herein with reference to the implement 10 shown in FIG. 1 as well as the system 100 shown in FIG. 2. However, it should be appreciated that the disclosed method 200 may be executed with implements having any other suitable configurations and/or with systems having any other suitable system configuration. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined and/or adapted in various ways without deviating from the scope of the present disclosure.

As shown in FIG. 3, at (202), the method 200 may include receiving data associated with a first fluid pressure of the fluid supplied to the first fluid chamber of the actuator. For example, as indicated above, sensor data may be received from the first pressure sensor 136 corresponding to the first fluid pressure supplied to the first fluid chamber 42 of the actuator 40.

Moreover, at (204), the method 200 may include receiving data associated with a second fluid pressure of the fluid supplied to the second fluid chamber of the actuator. For example, as indicated above, sensor data may be received from the second pressure sensor 138 corresponding to the second fluid pressure supplied to the second fluid chamber 44 of the actuator 40.

Further, at (206), the method 200 may include determining a pressure differential between the fluid supplied to the first and second fluid chambers of the actuator based on the data associated with the first and second fluid pressures. For example, as indicated above, a differential or difference between the data associated with the first and second fluid pressures received from the first and second pressure sensors 136, 138 may be determined and associated with a pressure differential between the fluid supplied to the first and second fluid chambers 42, 44.

Additionally, at (208), the method 200 may include controlling an operation of at least one of the first control valve or the second control valve to maintain the determined pressure differential within a target threshold range. Specifically, as indicated above, the operation of at least one of the first pressure regulating valve 122 or the second pressure regulating valve 124 may be controlled to maintain the pressure differential between the first and second fluid pressures within a target threshold range.

It is to be understood that the steps of the method 200 are performed by the controller(s) 102, 104 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller(s) 102, 104 described herein, such as the method 200, is implemented in software code or instructions which are tangibly stored on a tangible computer readable medium. The controller(s) 102,104 loads the software code or instructions via a direct interface with the computer readable medium or via a wired and/or wireless network. Upon loading and executing such software code or instructions by the controller(s) 102, 104, the controller(s) 102, 104 may perform any of the functionality of the implement controller 104 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for controlling downforce on a multi-wing agricultural implement, the system comprising:
a first frame section;
a second frame section pivotably coupled to the first frame section, the second frame section configured to support a plurality of row units;
an actuator configured to actuate the second frame section relative to the first frame section during operation of the agricultural implement to maintain downforce on the plurality of row units, the actuator defining a first fluid chamber and a second fluid chamber;
a first control valve configured to regulate a supply of fluid to the first fluid chamber of the actuator;
a second control valve configured to regulate a supply of fluid to the second fluid chamber of the actuator; and
a controller configured to control an operation of at least one of the first control valve or the second control valve to maintain a pressure differential between the fluid supplied to the first and second fluid chambers of the actuator within a target threshold range.

2. The system of claim 1, wherein the target threshold range is selected based on maintaining the downforce applied to the second frame section within a desired downforce range.

3. The system of claim 1, wherein the controller is configured to receive an input from an operator of the agricultural implement associated with a selection of the target threshold range.

4. The system of claim 1, further comprising first and second pressure sensors communicatively coupled to the controller, the first pressure sensor configured to provide data associated with a first fluid pressure of the fluid supplied to the first chamber of the actuator and the second pressure sensor configured to provide data associated with a second fluid pressure of the fluid supplied to the second chamber of the actuator.

5. The system of claim 4, wherein the controller is configured to analyze the data received from the first and second pressure sensors to determine the pressure differential between the fluid supplied to the first and second fluid chambers of the actuator.

6. The system of claim 5, wherein the controller is configured to compare the determined pressure differential to the target threshold range, and control the operation of the at least one of the first control valve or the second control valve to adjust the pressure differential between the fluid supplied to the first and second fluid chambers of the actuator when it is determined that the pressure differential falls outside the target threshold range.

7. The system of claim 1, wherein the first and second control valves comprise pressure regulating valves.

8. The system of claim 7, wherein the first and second control valves comprise solenoid-operated pressure regulating valves.

9. A method for controlling downforce on a multi-wing agricultural implement, the multi-wing agricultural implement having a first frame section, a second frame section pivotably coupled to the first frame section, and an actuator configured to actuate the second frame section relative to the first frame section, the actuator defining a first fluid chamber and a second fluid chamber, the agricultural implement further including a first control valve configured to regulate a supply of fluid to the first fluid chamber of the actuator, and a second control valve configured to regulate a supply of fluid to the second fluid chamber of the actuator, the method comprising:
receiving, with a computing device, data associated with a first fluid pressure of the fluid supplied to the first fluid chamber of the actuator;
receiving, with the computing device, data associated with a second fluid pressure of the fluid supplied to the second fluid chamber of the actuator;
determining, with the computing device, a pressure differential between the fluid supplied to the first and second fluid chambers of the actuator based on the data associated with the first and second fluid pressures; and
controlling, with the computing device, an operation of at least one of the first control valve or the second control valve to maintain the determined pressure differential within a target threshold range.

10. The method of claim 9, wherein the second frame section supports a plurality of row units of the agricultural implement, the target threshold range being selected based on maintaining a downforce applied to the second frame section within a desired downforce range.

11. The method of claim 9, further comprising receiving, with the computing device, an input from an operator of the agricultural implement associated with a selection of the target threshold range.

12. The method of claim 9, wherein receiving the data associated with the first and second fluid pressures comprises receiving the data from first and second pressure sensors, respectively.

13. The method of claim 9, further comprising comparing, with the computing device, the determined pressure differential to the target threshold range;
wherein controlling the operation of the at least one of the first control valve or the second control valve comprises controlling the operation of the at least one of the first control valve or the second control valve to adjust the pressure differential between the fluid supplied to the first and second fluid chambers of the actuator when it is determined that the pressure differential falls outside the target threshold range.

14. The method of claim 9, wherein the first and second control valves comprise pressure regulating valves.

15. The method of claim 14, wherein the first and second control valves comprise solenoid-operated pressure regulating valves.
